(19) United States
(12) Patent Application Publication
(10) Pub. No.: US 2010/0269297 A1
(43) Pub. Date: Oct. 28, 2010

(54) HINGE AND INTERFERING ASSEMBLY THEREOF

(75) Inventor: Wen-Bin Shen, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/497,708

(22) Filed: Jul. 6, 2009

(30) Foreign Application Priority Data
Apr. 28, 2009 (CN) 200910301925.9

(51) Int. Cl. E05D 11/10

(52) U.S. Cl. 16/347

(57) ABSTRACT

A hinge includes a shaft with a post, a bracket, a first interfering member, and a second interfering member. The bracket defines a pivoting hole for the post of the shaft rotatably extending through the bracket. The first interfering member is mounted on the shaft. The first interfering member forms a raised portion with a first sloped surface and a first protrusion. The second interfering member is mounted to the bracket and rotatably arranged around the post of the shaft. The second interfering member includes a recessed portion with a second sloped surface and a second protrusion. The raised portion of the first interfering member is engagable with the recessed portion of the second interfering member, the first protrusion of the first interfering member is operated to resist against the second protrusion of the second interfering member for positioning the shaft with respect to the bracket.

### BACKGROUND

1. Technical Field

The disclosure relates to a hinge and an interfering assembly of the hinge.

2. Description of Related Art

A collapsible device, such as a notebook computer, or a clamshell mobile phone, generally including a main body and a cover, often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at any angle with respect to the main body. During rotation, the cover can maintain at any angle with respect to the main body by friction between the first and second elements. However, because the first and second elements are not durable, after frequent usage, wear and tear results in preventing the cover from being able to stay at certain desirable positions. When one of the first or second elements is worn out, the cover cannot maintain stability at certain desirable positions with respect to the main body, which is quite inconvenient for users. Even worse, the cover can be easily over-rotated resulting in damaging the hinge.

### BRIEF DESCRIPTION OF THE DRAWINGS

FIG. 1 is an assembled, isometric view of an exemplary embodiment of a hinge, the hinge includes an interfering assembly.

FIGS. 2 and 3 are exploded, isometric views of the hinge of FIG. 1, but viewed from different perspectives.

FIG. 4 is an exploded, enlarged view of the interfering assembly of FIG. 1.

### DETAILED DESCRIPTION

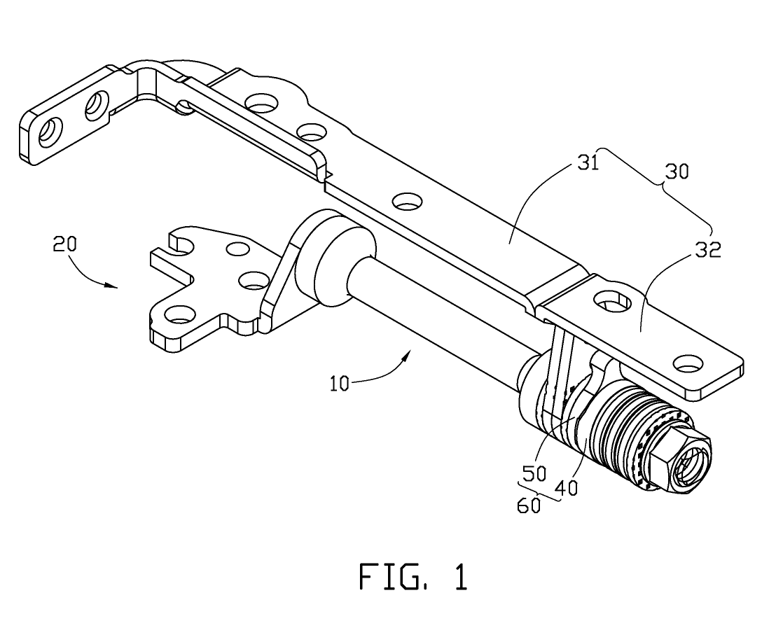

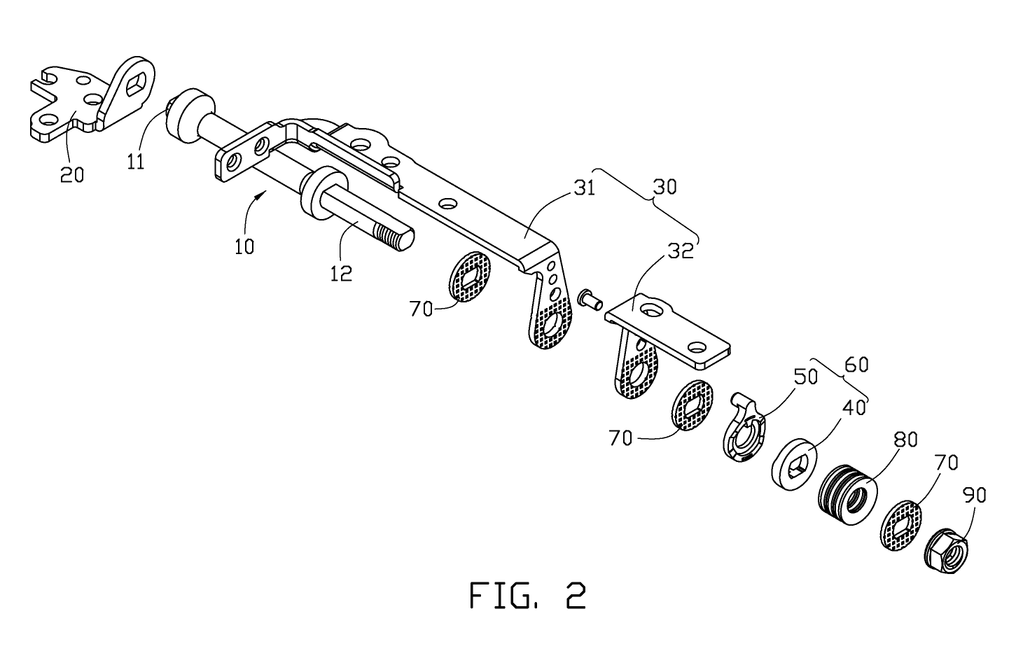

Referring to FIGS. 1 and 2, an exemplary embodiment of a hinge is adapted to be mounted to a foldable device, such as a notebook computer or a clamshell mobile phone, which includes two parts rotatably connected to each other via the hinge. The hinge includes a shaft 10, a rack 20 mounted to one part of the foldable device (not labeled in pictures), a bracket 30 mounted to the other part of the foldable device (not labeled in pictures), an interfering assembly 60, three friction pieces 70, a resilient assembly 80, and a fastener 90.

The shaft 10 includes a post 12 and a fixed portion 11, extending from two opposite ends of the shaft 10. The fixed portion 11 is used for fixing the shaft 10 to the rack 20. The post 12 has a noncircular, such as double-D shaped, cross section. A free end of the post 12 forms a threaded portion.

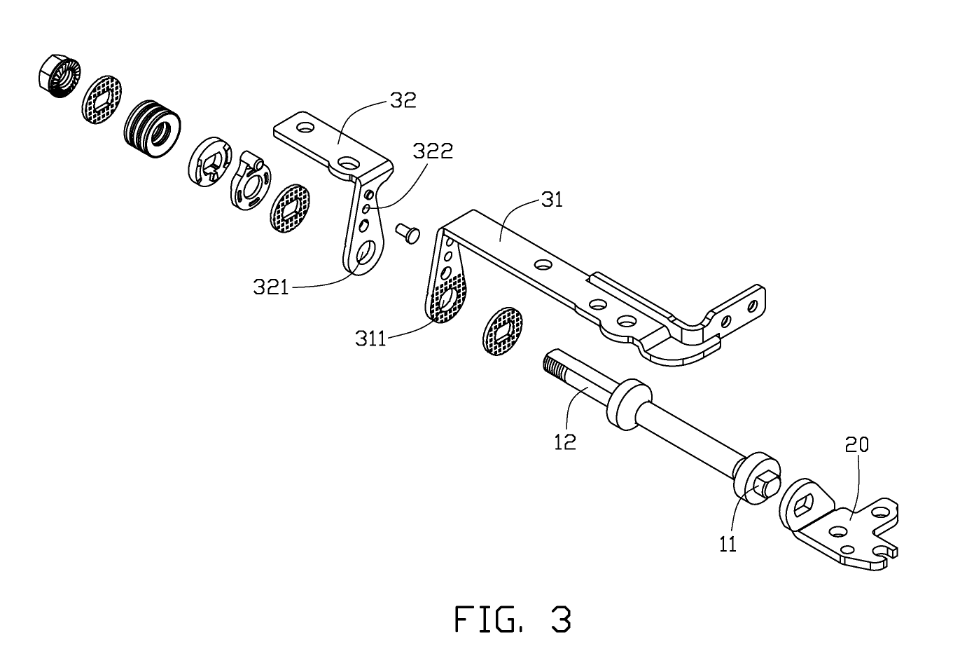

Referring to FIG. 3, the bracket 30 includes a first pivoting member 31 and a second pivoting member 32. The first and second pivoting members 31 and 32 are fixed together via fasteners such as rivets or screws. Alternatively, the first pivoting member 31 and the second pivoting member 32 may be integrally formed. The first and second pivoting members 31 and 32 define a plurality of mounting holes to fix the first and second pivoting members 31 and 32 to the foldable device. The first pivoting member 31 forms a bent portion at an end of the first pivoting member 31, adjacent to the second pivoting member 32. The bent portion of the first pivoting member 31 defines a first pivoting hole 311 allowing the post 12 to extend therethrough. The second pivoting member 32 forms a bent portion at an end adjacent to the first pivoting member 31. The bent portion of the second pivoting member 32 defines a second pivoting hole 321 allowing the post 12 to extend therethrough. A mounting hole 322 is defined in the bent portion of the second pivoting member 32, adjacent to the second pivoting hole 321.

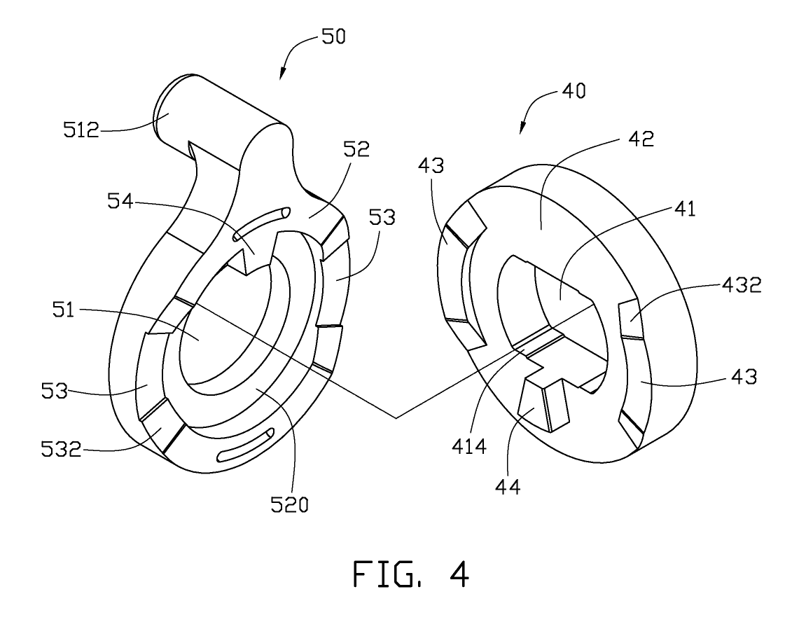

Referring to FIG. 4, the interfering assembly 60 includes a first interfering member 40 and a second interfering member 50 engagable with and rotatable relative to the first interfering member 40. The first interfering member 40 is generally cylindrical-shaped, defining a double-D shaped through hole 41, to snugly fit about the post 12. A plurality of wedges 414 is formed on a sidewall bounding the through hole 41, for firmly mounting the first interfering member 40 on the post 12. The second interfering member 50 is generally cylindrical-shaped, defining a round through hole 51 for rotatably receiving the post 12. An inserting pillar 512 is formed on a circumference of the second interfering member 50, for being inserted into the mounting hole 322 of the second pivoting member 32 of the bracket 30, to fix the second interfering member 50 to the second pivoting member 32.

The first interfering member 40 includes a first surface 42 facing the second interfering member 50. Two raised portions 43 protrude on the first surface 42, opposite to each other and along a circumference of the first interfering member 40. Opposite ends of each of the raised portions 43 form two sloped surfaces 432 connecting to the first surface 42. A protrusion 44 is formed on the first surface 42 adjacent to the through hole 41 of the first interfering member 40.

The second interfering member 50 includes a second surface 52 facing the first interfering member 40. Two recessed portions 53 are defined in the second surface 52, opposite to each other and along a circumference of the second interfering member 50. Opposite ends of each of the recessed portions 53 form two sloped surfaces 532 connecting to the second surface 52. A depressed portion 520 is defined in the second surface 52, adjacent to and around the through hole 51. A protrusion 54 is protruded on a bottom wall of the recessed surface 520. A top surface of the protrusion 54 and the second surface 52 are coplanar.

Each friction piece 70 defines a double-D shaped through hole for receiving the post 12. Each friction piece 70 defines a plurality of receiving holes (not labeled), for retaining lubricant therein.

The resilient assembly 80 includes a plurality of resilient pieces, each of which defines a round through hole (not labeled) for rotatably receiving the post 12. These resilient pieces are stacked together on the post 12. In an alternative embodiment, the resilient assembly 80 can include springs or other types of resilient components.

In the illustrated embodiment, the fastener 90 is a nut, and can be screwed onto the threaded portion of the post 12.

Referring to FIGS. 1 through 4, in assembly, the post 12 of the shaft 10 is inserted through the through hole of a first friction piece 70 of the friction pieces 70, the first pivoting hole 311 of the first pivoting member 31, the second pivoting hole 321 of the second pivoting member 32, the through hole of a second friction piece 70 of the friction pieces 70, the through hole 51 of the second interfering member 50, the through hole 41 of the first interfering member 40, the through holes of the resilient assembly 80, the through hole of a third friction piece of the friction pieces 70 in that order, to be screwed to the fastener 90.

In use, when a part of the collapsible device rotates with respect to the other part of the collapsible device to close the collapsible device, the shaft 10 rotates relative to the bracket 30. The first interfering member 40 rotates with the shaft 10. When the sloped surfaces 432 of the first interfering member 40 engage with the corresponding sloped surfaces 532 of the second interfering member 50, the raised portions 43 of the first interfering member 40 slide into the recessed portions 53 of the second interfering member 50, respectively and automatically by guidance of these sloped surfaces 432 and 532. Thereby, the collapsible device is automatically and completely closed. When a part of the collapsible device rotates with respect to the other part of the collapsible device to open the collapsible device, the shaft 10 rotates relative to the bracket 30. The first interfering member 40 rotates with the shaft 10, until the protrusion 44 of the first interfering member 40 resists against the protrusion 54 of the second interfering member 50. Therefore the one part of the foldable device may be positioned with respect to the other part of the foldable device at desired angles.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a shaft comprising a post;
a bracket defining a pivoting hole for the post of the shaft rotatably extending therethrough;
a first interfering member mounted on the shaft, the first interfering member comprising a raised portion with a first sloped surface, and a first protrusion; and
a second interfering member mounted to the bracket and rotatably arranged around the post of the shaft, the second interfering member comprising a recessed portion with a second sloped surface and a second protrusion;
wherein the raised portion of the first interfering member is engagable with the recessed portion of the second interfering member by guidance of the first and second slop surfaces, the first protrusion of the first interfering member is operated to resist against the second protrusion of the second interfering member for positioning the shaft with respect to the bracket.

2. The hinge of claim 1, wherein the first interfering member comprises a first surface facing the second interfering member, the raised portion protrudes on the first surface along a circumference of the first interfering member.

3. The hinge of claim 2, wherein the first interfering member defines a through hole in a centre of the first interfering member, for the post extending therethrough, the first protrusion is formed on the first surface, adjacent to the through hole of the first interfering member.

4. The hinge of claim 1, wherein the post has a double-D shaped cross section, the first interfering member is generally cylindrical-shaped and defines a double-D shaped through hole, to snugly fit about the post.

5. The hinge of claim 4, wherein at least one wedge is formed on a sidewall bounding the through hole of the first interfering member, for firmly mounting the first interfering member on the shaft.

6. The hinge of claim 1, wherein the bracket defines a mounting hole, and an inserting pillar is formed on a circumference of the second interfering member, for being inserted into the mounting hole to mount the second interfering member to the bracket.

7. The hinge of claim 1, wherein the second interfering member comprises a second surface facing the first interfering member, the recessed portion is defined in the second surface along a circumference of the second interfering member.

8. The hinge of claim 7, wherein the second interfering member defines a through hole for the post of the shaft extending therethrough, a depressed portion is defined in the second surface adjacent to and around the through hole, the second protrusion protrudes on a bottom wall of the depressed portion, adjacent to and around the through hole.

9. The hinge of claim 8, wherein a top surface of the protrusion and the second surface of the second interfering member are coplanar.

10. The hinge of claim 1, further comprising a resilient assembly rotatably retained on the shaft for packing the first interfering member and the second interfering member together.

11. An interfering assembly comprising:
a first interfering member comprising a raised portion with a first sloped surface, and a first protrusion; and
a second interfering member comprising a recessed portion with a second sloped surface, and a second protrusion;
wherein the raised portion of the first interfering member is engagable with the recessed portion of the second interfering member by guidance of the first and second slop surfaces, the first protrusion of the first interfering member is operable of resisting against the second protrusion of the second interfering member for positioning the shaft with respect to the bracket.

12. The interfering assembly of claim 11, wherein the first interfering member comprises a first surface facing the second interfering member, the raised portion protrudes on the first surface along a circumference of the first interfering member.

13. The interfering assembly of claim 12, wherein the first interfering member defines a through hole in a centre of the first interfering member for the post extending therethrough, the first protrusion is formed on the first surface, adjacent to the through hole of the first interfering member.

14. The interfering assembly of claim 11, wherein the post has a double-D shaped cross section, the first interfering member is generally cylindrical-shaped and defines a double-D shaped through hole.

15. The interfering assembly of claim 14, wherein at least one wedge is formed on a sidewall bounding the through hole of the first interfering member.

16. The interfering assembly of claim 11, wherein the second interfering member comprises a second surface facing the first interfering member, the recessed portion is defined in the second surface along a circumference of the second interfering member.

17. The interfering assembly of claim 16, wherein the second interfering member defines a through hole for the post of the shaft extending therethrough, a depressed portion is defined in the second surface around the through hole, the second protrusion protrudes on a bottom wall of the depressed portion around the through hole.

18. The interfering assembly of claim 17, wherein a top surface of the second protrusion and the second surface of the second interfering member are coplanar.
